(19) United States
(12) Patent Application Publication
(10) Pub. No.: US 2024/0145853 A1
(43) Pub. Date: May 2, 2024

(54) SECONDARY BATTERY

(71) Applicant: SAMSUNG SDI CO., LTD., Yongin-si (KR)

(72) Inventor: Dae Kyu KIM, Yongin-si (KR)

(21) Appl. No.: 18/376,472

(22) Filed: Oct. 4, 2023

(30) Foreign Application Priority Data
Oct. 27, 2022 (KR) 10-2022-0140277

(51) Int. Cl. H01M 50/367; H01M 50/152

(52) U.S. Cl. CPC H01M 50/367; H01M 50/152

(57) ABSTRACT

The present disclosure provides a secondary battery capable of preventing corrosion of a cap up or a safety vent due to a remaining cleaning liquid. Disclosed in an example is a secondary battery including: an electrode assembly; a case accommodating the electrode assembly; and a cap assembly coupled to an upper portion of the case, including a cap up, a safety vent installed below the cap up, and a cap down installed below the safety vent and electrically connected to the electrode assembly, wherein the safety vent includes a discharge passage formed on a surface in contact with the cap up.

### CROSS-REFERENCE TO RELATED APPLICATION

This application claims priority to and the benefit of Korean Patent Application No. 10-2022-0140277 filed on Oct. 27, 2022 in the Korean Intellectual Property Office, the contents of which in its entirety are herein incorporated by reference.

### BACKGROUND

### 1. Field

The present disclosure relates to a secondary battery.

### 2. Description of the Related Art

Unlike a primary battery that cannot be charged, a secondary battery is a battery that can be charged and discharged. Low-capacity batteries are used in portable small electronic devices such as smart phones or digital cameras, and large-capacity batteries in the form of a module in which dozens to hundreds of battery packs are connected are widely used as power sources for driving motors in hybrid vehicles, electric vehicles, or energy storage devices. Such lithium ion secondary batteries can be classified into cylindrical, prismatic, and pouch-type secondary batteries in terms of shape.

Specifically, a cylindrical lithium ion secondary battery generally includes a cylindrical electrode assembly, a cylindrical case to which the electrode assembly is coupled, an electrolyte injected inside the case to allow movement of lithium ions, and a cap assembly which is coupled to one side of the case to prevent electrolyte leakage and prevents the electrode assembly from being separated.

Meanwhile, after assembling the secondary battery, an external cleaning liquid may remain in gaps inside the cap assembly, and the cap assembly may be corroded by the gas generated from the cleaning liquid.

The above information disclosed in this Background section is only for enhancement of understanding of embodiments and therefore it may contain information that does not constitute prior art.

### SUMMARY

Embodiments are directed a secondary battery capable of preventing corrosion of a cap up or a safety vent due to a remaining cleaning liquid.

A secondary battery according to the present disclosure may include: an electrode assembly; a case accommodating the electrode assembly; and a cap assembly coupled to an upper portion of the case, including a cap up, a safety vent installed below the cap up, and a cap down installed below the safety vent and electrically connected to the electrode assembly, wherein the safety vent includes a discharge passage formed on a surface in contact with the cap up.

The safety vent may include: a vent center portion formed at the center and spaced apart from the cap up; a vent contact portion extending outward from the center of the vent and contacting a lower surface of the cap up; and a vent extension portion bent from the vent contact portion and extending to an upper portion of the cap up.

The discharge passage may be formed on an upper surface of the vent contact portion.

The discharge passage may be formed in a portion adjacent to the vent center portion on the vent contact portion.

A depth of the discharge passage may be 0.05 mm or less.

The discharge passage may include: a plurality of annular passages having concentric circles; a plurality of straight passages connected to the plurality of annular passages and radially formed and spaced apart from each other; and a plurality of partition walls interposed between the plurality of annular passages.

The straight passages may open portions of the interface between the vent contact portion and the vent center portion.

The straight passages may be formed to be inclined so as to increase in depth from the outside to the inside.

The annular passages may include: a first annular passage having a first diameter; and a second annular passage having a second diameter greater than the first diameter, and a depth of the first annular passage may be greater than a depth of the second annular passage.

The partition walls may include: a first partition wall located inside the first annular passage; and a second partition wall interposed between the first annular passage and the second annular passage, and the first partition wall and the second partition wall may be separated into a plurality of parts by the straight passages.

The annular passages may further include a third annular passage having a third diameter greater than the second diameter, and a depth of the second annular passage may be greater than a depth of the third annular passage.

The partition walls may further include a third partition wall interposed between the second annular passage and the third annular passage.

The cap up may include: a terminal portion convexly formed upward in the center; and a coupling portion positioned on an outer periphery of the terminal portion and to which the safety vent is coupled, and the discharge passage may face a lower surface of the coupling portion.

### BRIEF DESCRIPTION OF DRAWINGS

Features will become apparent to those of skill in the art by describing in detail exemplary embodiments with reference to the attached drawings in which:

FIG. 1 is a cross-sectional view illustrating a secondary battery according to an embodiment of the present disclosure.

FIG. 2 is a cross-sectional view illustrating a cap assembly in a secondary battery according to an embodiment of the present disclosure.

FIG. 3 is an enlarged cross-sectional view of a portion of the cap assembly of FIG. 2.

FIG. 4A is a plan view illustrating a safety vent according to an embodiment of the present disclosure.

FIG. 4B is a cross-sectional view taken along line A-A of FIG. 4A.

FIG. 4C is a cross-sectional view taken along line B-B of FIG. 4A.

FIG. 5A is a plan view illustrating a safety vent according to another embodiment of the present disclosure.

FIG. 5B is a cross-sectional view taken along line C-C of FIG. 5A.

FIG. 5C is a cross-sectional view taken along line D-D of FIG. 5A.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise” and/or “comprising,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Preferred embodiments of the present disclosure will now be described in detail with reference to the accompanying drawings to the extent that a person skilled in the art to which the present disclosure belongs can easily implement the present disclosure.

Here, the same reference numerals are attached to parts having similar configurations and operations throughout the specification. In addition, when a part is said to be electrically coupled to another part, this includes not only a case where it is directly connected but also a case where it is connected with another element interposed therebetween.

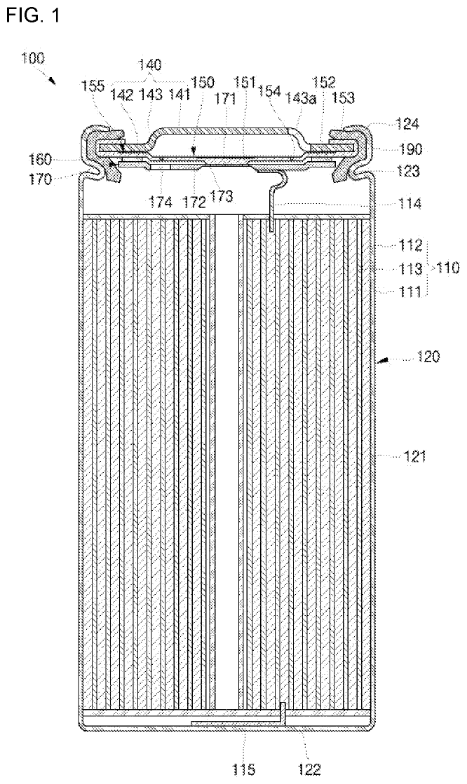

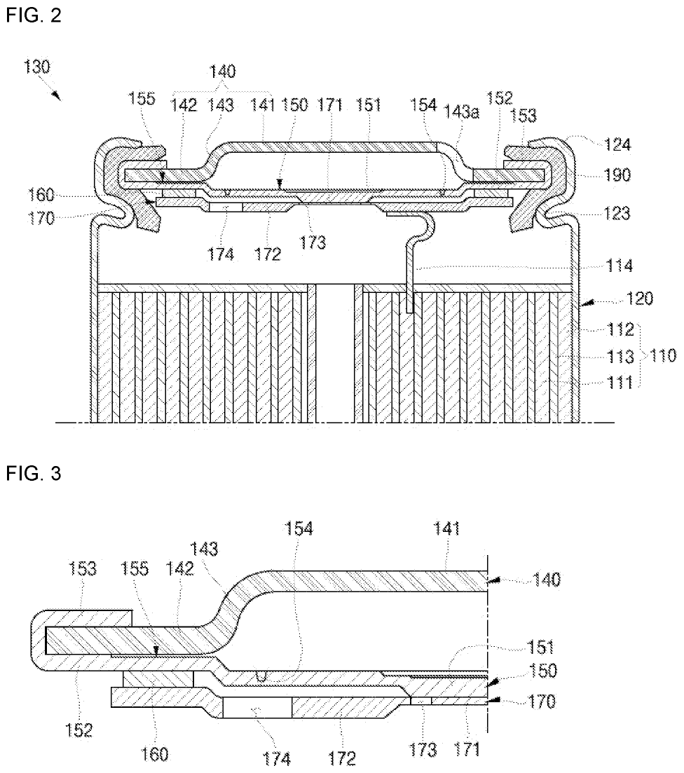

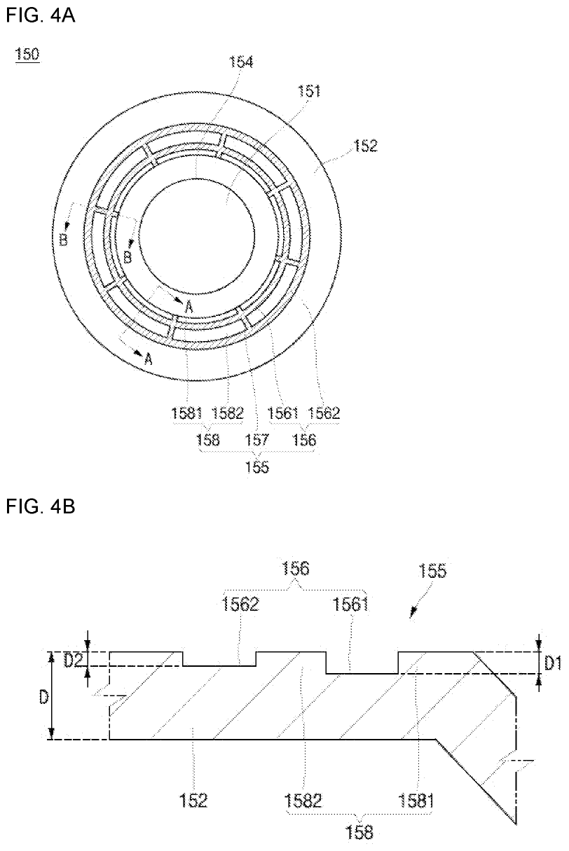

FIG. 1 is a cross-sectional view illustrating a secondary battery according to an embodiment of the present disclosure. FIG. 2 is a cross-sectional view illustrating a cap assembly in a secondary battery according to an embodiment of the present disclosure. FIG. 3 is an enlarged cross-sectional view of a portion of the cap assembly of FIG. 2.

Referring to FIGS. 1 to 3, the secondary battery 100 according to an embodiment of the present disclosure may include an electrode assembly 110, a case 120, a cap assembly 130, and a gasket 190.

The electrode assembly 110 includes a first electrode 111, a second electrode 112, and a separator 113 interposed between the first electrode 111 and the second electrode 112. The electrode assembly 110 may be formed by winding a laminate of the first electrode 111, the separator 113, and the second electrode 112 in a jelly-roll shape. Here, the first electrode 111 may act as a positive electrode, and the second electrode 112 may act as a negative electrode. A first electrode tab 114 is connected to the cap assembly 130 on the electrode assembly 110, and a second electrode tab 115 is connected to a bottom plate 122 of the case 120, the bottom plate being under the electrode assembly 110.

The first electrode 111 is formed by applying a first electrode active material such as a transition metal oxide to a first electrode current collector formed of a metal foil such as aluminum. A first electrode uncoated portion to which the first electrode active material is not applied is formed on the first electrode 111, and a first electrode tab 114 is attached to the first electrode uncoated portion. One end of the first electrode tab 114 is electrically connected to the first electrode 111, and the other end thereof protrudes upward from the electrode assembly 110 and is electrically connected to the cap assembly 130.

The second electrode 112 is formed by applying a second electrode active material such as graphite or carbon to a second electrode current collector formed of a metal foil such as copper or nickel. A second electrode uncoated portion of the to which the second electrode active material is not applied is formed on the second electrode 112, and a second electrode tab 115 is attached to the uncoated portion of the second electrode. One end of the second electrode tab 115 is electrically connected to the second electrode 112, and the other end thereof protrudes downward from the electrode assembly 110 and is electrically connected to an upward-facing surface of the bottom plate 122 of the case 120.

The separator 113 is positioned between the first electrode 111 and the second electrode 112 to prevent a short circuit and to enable the movement of lithium ions. The separator 113 may be made of polyethylene, polypropylene, or a composite film of polyethylene and polypropylene.

The case 120 includes a side surface plate 121, which is a cylindrical body having a predetermined diameter so as to form a space in which the electrode assembly 110 is accommodated, and the bottom plate 122, which seals a lower portion of the side surface plate 121. A top opening of the case 120 may be opened so as to be sealed after inserting the electrode assembly 110 into the case 120. In addition, a beading part 123 for preventing movement of the electrode assembly 110 may be formed on the top of the case 120. In addition, a crimping part 124 for fixing the cap assembly 130 and the gasket 190 may be formed at the uppermost end of the case 120. The crimping part 124 may include a gasket 190 interposed therein and may be formed to press the cap assembly 130 to prevent separation of the cap assembly 130 and leakage of an electrolyte.

The cap assembly 130 may include a cap up 140, a safety vent 150, an insulator 160, and a cap down 170.

The cap up 140 may be formed as a circular plate body, and may include a terminal portion 141 that extends upwardly and convexly formed at the center, a coupling portion 142 located on the outer periphery of the terminal portion 141, and a connection portion 143 that connects the terminal portion 141 to the coupling portion 142. The terminal portion 141 protrudes upward relative to the coupling portion 142 and serves as a terminal that is electrically connected to an external circuit. The terminal portion 141 may be electrically connected to the first electrode tab 114 and may act as, for example, a positive electrode. The coupling portion 142 may be located on the outer periphery of the terminal portion 141, and the safety vent 150 may be coupled to the coupling portion 142. In some implementations, the coupling portion 142 may be formed to have a thickness greater than the terminal portion 141. Accordingly, the coupling portion 142 may prevent the cap up 140 from being deformed when the crimping part 124 is formed for coupling the cap assembly 130 to the case 120. A vent extension portion 153 of the safety vent 150 may be coupled to an upper portion of the coupling portion 142. The connection portion 143 may connect the terminal portion 141 to the coupling portion 142 and may be formed so as to be inclined. The connection portion 143 may have a gas discharge hole 143a formed therein. A plurality of gas discharge holes 143a may be formed in the connection portion 143 and may provide a path through which gas generated inside the case 120 can be discharged. In addition, some of the gas discharge holes 143a may extend to the terminal portion 141 and the coupling portion 142.

The safety vent 150 may be formed as a circular plate body corresponding to the cap up 140 and may be coupled to a lower portion of the cap up 140. The safety vent 150 may include a vent center portion 151, a vent contact portion 152 located outside the vent center portion 151 and contacting the coupling portion 142 of the cap up 140, and a vent extension portion 153 bent from the vent contact portion 152 and extending to cover an upper surface of the cap up 140. In some examples, the upper portion of the vent extension portion 153 may be fixed on the cap up 140 by welding. Here, the safety vent 150 and the cap up 140 may be welded by laser welding, ultrasonic welding, resistance welding, or an equivalent method thereof.

The vent center portion 151 may be located at the center of the safety vent 150 and may be formed to be spaced apart from the cap up 140. In addition, the cap down 170 may be electrically connected to a lower surface of the vent center portion 151. The vent center portion 151 may include a notch 154 that guides the rupture of the safety vent 150. The notch 154 may be formed at a position corresponding to a gas discharge hole of the cap down 170. Accordingly, the notch 154 may be ruptured by the gas discharged through the gas discharge hole.

The vent contact portion 152 may extend outward from the vent center portion 151. In addition, the vent contact portion 152 may extend upward from the vent center portion 151. That is, a step may be formed between the vent contact portion 152 and the vent center portion 151. The vent contact portion 152 may include a discharge passage 155 for discharging a cleaning liquid. In general, after assembling the secondary battery 100, a process of washing with a cleaning liquid may be included. Here, the cleaning liquid might remain in a gap between the safety vent 150 and the cap up 140, and hydrogen fluoride (HF) gas could be generated from the cleaning liquid. If hydrogen fluoride (HF) gas is generated, corrosion could occur in the cap up 140 or the safety vent 150. Accordingly, in the safety vent 140 of the present disclosure, by including the discharge passage 155 through which a cleaning liquid may be discharged, corrosion of the cap up 140 or the safety vent 150 that could be due to hydrogen fluoride (HF) gas generated from the remaining cleaning liquid can be prevented.

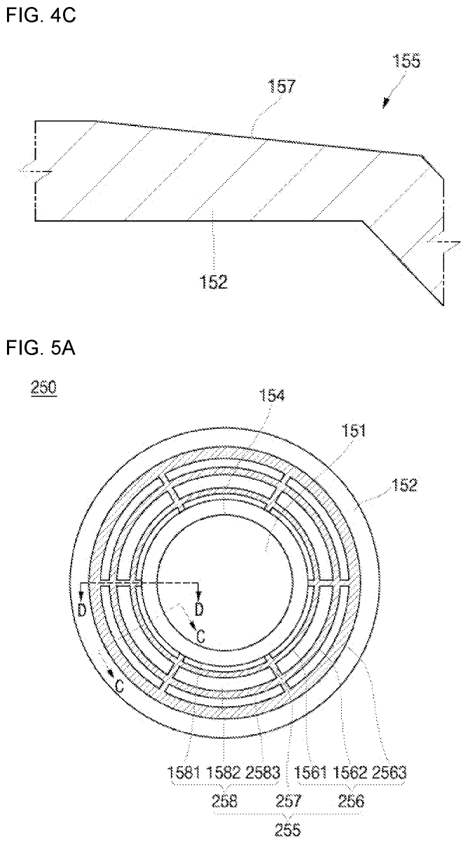

FIG. 4A is a plan view illustrating a safety vent according to an embodiment of the present disclosure. FIG. 4B is a cross-sectional view taken along line A-A of FIG. 4A. FIG. 4C is a cross-sectional view taken along line B-B of FIG. 4A. Here, for describing a discharge passage, FIG. 4A shows a plan view of the safety vent in a state in which a vent extension portion is removed therefrom.

Referring to FIGS. 4A to 4C, the discharge passage 155 may be formed in a portion adjacent to the vent center portion 151 in the vent contact portion 152. In addition, the discharge passage 155 may be formed on an upper surface of the vent contact portion 152 and may face the coupling portion 142 of the cap up 140. For example, the discharge passage 155 may be formed only in a portion adjacent to the vent center portion 151 in the vent contact portion 152. Of course, the discharge passage 155 may also be formed on the entire vent contact portion 152. The discharge passage 155 may be formed to have a depth D1 of about 0.05 mm or less. If the depth D1 of the discharge passage 155 were to be greater than 0.05 mm, the inflow of a cleaning liquid might increase due to a reversal phenomenon. Here, the term “depth D1 of the discharge passage 155” may refer to a depth of a passage having the largest depth among the plurality of passages.

The discharge passage 155 may include an annular passage 156 and a straight passage 157. In some examples, the discharge passage 155 may be referred to as, or include, a channel, a trench, or a notch.

Referring to FIGS. 4A and 4B, the annular passage 156 may include a plurality of passages. The annular passage 156 may include a first annular passage 1561 and a second annular passage 1562. The first annular passage 1561 may be a passage having a first diameter. The second annular passage 1562 may be a passage having a second diameter greater than the first diameter. The second annular passage 1562 may be located outside the first annular passage 1561. That is, the first annular passage 1561 and the second annular passage 1562 may form concentric circles. In some examples, the depth D1 of the first annular passage 1561 may be greater than the depth D2 of the second annular passage 1562.

Referring to FIGS. 4A and 4C, the straight passage 157 connects the first annular passage 1561 and the second annular passage 1562 and may be formed radially. The straight passage 157 may include a plurality of passages spaced apart from each other. Although the straight passage 157 is shown as being eight straight passages in FIG. 4A, the number of straight passages 157 may also be more than or less than eight. The straight passage 157 may be formed to open one end of the vent contact portion 152. Specifically, the straight passage 157 may be formed to open a portion of an interface between the vent contact portion 152 and the vent center portion 151. Accordingly, cleaning liquid that may remain between the cap up 140 and the safety vent 150 may be discharged to the vent center portion 151 of the safety vent 150 along the straight passage 157.

In some examples, in order to facilitate the discharge of the cleaning liquid, the straight passage 157 may be formed to be inclined so as to increase in depth from the outside to the inside. In other words, the straight passage 157 may increase in depth from the second annular passage 1562 to the first annular passage 1561. In addition, the straight passage 157 may become deeper toward the vent center portion 151.

In addition, the discharge passage 155 may include partition walls 158 positioned between the plurality of annular passages 156. The partition walls 158 may include a first partition wall 1581 located inside the first annular passage 1561 and a second partition wall 1582 located between the first annular passage 1561 and the second annular passage 1562. The first annular passage 1561 may be defined by the first partition wall 1581 and the second partition wall 1582. In addition, the first partition wall 1581 and the second partition wall 1582 may be separated into a plurality of parts by the straight passage 157.

As described above, the cleaning liquid introduced between the cap up 140 and the safety vent 150 may be located in the annular passages 156 and discharged to the inside of the safety vent 150 through the straight passage 157. Accordingly, in the present disclosure, it is possible to prevent corrosion of the cap up 140 or the safety vent 150 that could be caused by the cleaning liquid.

The vent extension portion 153 may be bent upward from the vent contact portion 152 and may extend toward an upper surface of the coupling portion 142 of the cap up 140. The vent extension portion 153 may cover a portion of the coupling portion 142 of the cap up 140. The vent extension portion 153 may be interposed between the coupling portion 142 and the gasket 190.

The insulator 160 may be interposed between the safety vent 150 and the cap down 170 to insulate the safety vent 150 and the cap down 170 from each other. For example, the insulator 160 may be formed in a ring shape and may be interposed between the vent contact portion 152 of the safety vent 150 and the outer periphery of the cap down 170. The insulator 160 may be made of a resin material such as polyethylene (PE), polypropylene (PP), or polyethylene terephthalate (PET).

The cap down 170 may be formed as a circular plate body. The cap down 170 may include a first region 171 electrically connected to the vent center portion 151 of the safety vent 150 and a second region 172 extending outwardly from the first region 171. The first region 171 may be formed to have a smaller thickness than the second region 172. The first region 171 may be separated from the second region 172 by gas generated inside the case 120. In addition, a center hole 173 may be formed between the first region 171 and the second region 172. The center hole 173 may discharge internal gas. At the same time, the first region 171 may be easily separated from the second region 172. For example, the center hole 173 may include a plurality of holes spaced apart from each other between the first region 171 and the second region 172. In some examples, the center hole 173 may be a roughly “c” shaped hole. That is, the center hole 173 may not completely separate the first region 171 and the second region 172.

The first electrode tab 114 may be electrically connected to a lower surface of the second region 172. In addition, a gas discharge hole 174 may be formed in the second region 172. The gas discharge hole 174 may serve to discharge internal gas when excessive internal pressure is generated inside the case 120. Here, the vent center portion 151 of the safety vent 150 may be raised by the gas discharged through the gas discharge hole 174, and the first region 171 of the cap down 170 may be separated from the second region 172, so that the safety vent 150 may be electrically separated from the cap down 170. Subsequently, the notch 154 of the safety vent 150 may be ruptured so that the internal gas can be discharged through the gas discharge hole 143a of the cap up 140.

The gasket 190 may be installed in the top opening of the case 120. That is, the gasket 190 may be assembled in close contact between the outer peripheries of the cap up 140, the safety vent 150, and the top opening of the case 120. The gasket 190 may be in close contact with the vent contact portion 152 and the vent extension portion 153 of the safety vent 150. The gasket 190 may be made of a resin material such as polyethylene (PE), polypropylene (PP), or polyethylene terephthalate (PET). The gasket 190 may electrically insulate the case 120 and the cap assembly 130 from each other.

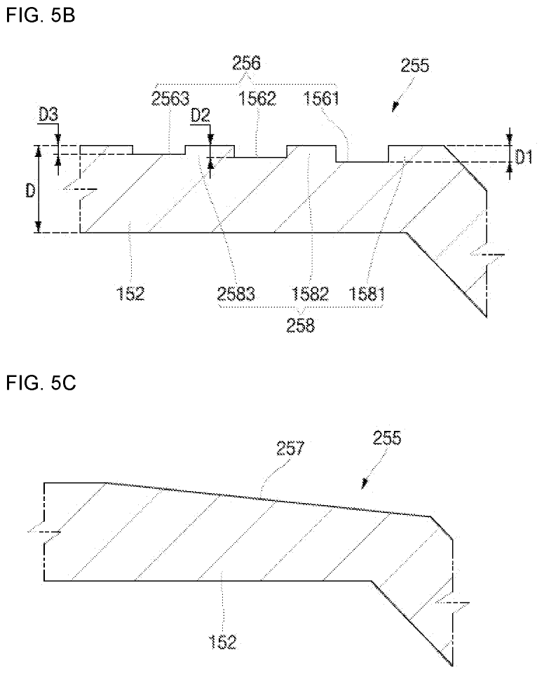

FIG. 5A is a plan view illustrating a safety vent according to another embodiment of the present disclosure. FIG. 5B is a cross-sectional view taken along line C-C of FIG. 5A. FIG. 5C is a cross-sectional view taken along line D-D of FIG. 5A. Here, for describing a discharge passage, FIG. 5A shows a plan view of the safety vent in a state in which a vent extension portion is removed therefrom.

Referring to FIGS. 5A to 5C, a discharge passage 255 may include an annular passage 256 and a straight passage 257.

Referring to FIGS. 5A and 5B, the annular passage 256 may include one or more passages. The annular passage 256 may include a first annular passage 1561, a second annular passage 1562, and a third annular passage 2563. The first annular passage 1561 may be a passage having a first diameter. The second annular passage 1562 may be a passage having a second diameter greater than the first diameter. The third annular passage may be a passage having a third diameter greater than the second diameter. The third annular passage 2563 may be located outside the second annular passage 2563. That is, the first annular passage 1561, the second annular passage 1562, and the third annular passage 2563 may form concentric circles. In some examples, a depth of the second annular passage 1562 may be greater than a depth of the third annular passage 2563.

Referring to FIGS. 5A and 5C, the straight passage 257 connects the first annular passage 1561, the second annular passage 1562, and the third annular passage 2563 to one another, and may be formed radially. Although the straight passage 257 is shown as being six straight passages in FIG. 5A, the number of straight passages 257 may also be more than or less than six. The straight passage 257 may be formed to open one end of the vent contact portion 152. Specifically, the straight passage 257 may be formed to open a portion of an interface between the vent contact portion 152 and the vent center portion 151. Accordingly, any cleaning liquid remaining between the cap up 140 and the safety vent 150 may be discharged to the vent center portion 151 of the safety vent 150 along the straight passage 257. In some examples, in order to facilitate the discharge of the cleaning liquid, the straight passage 257 may be formed to be inclined so as to increase in depth from the outside to the inside.

In addition, the discharge passage 255 may include partition walls 258 located between the plurality of annular passages 256. The partition walls 258 may include a first partition wall 1581 located inside the first annular passage 1561, a second partition wall 1582 located between the first annular passage 1561 and the second annular passage 1562, and a third partition wall 2583 located between the annular passage 1562 and the third annular passage 2563. The second annular passage 1562 may be defined by the second partition wall 1582 and the third partition wall 2583. In addition, each of the first partition wall 1581, the second partition wall 1582, and the third partition wall 2583 may be separated into a plurality of parts by the straight passage 257.

As described above, in the secondary battery according to the present disclosure, by forming in a safety vent a discharge passage through which a cleaning liquid may be discharged, it is possible to prevent corrosion of a cap up or safety vent due to a remaining cleaning liquid.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery comprising:
an electrode assembly;
a case accommodating the electrode assembly; and
a cap assembly coupled to an upper portion of the case, including a cap up, a safety vent installed below the cap up, and a cap down installed below the safety vent and electrically connected to the electrode assembly,
wherein the safety vent includes a discharge passage formed on a surface in contact with the cap up.

2. The secondary battery as claimed in claim 1, wherein the safety vent includes:
a vent center portion formed at a center and of the safety vent spaced apart from the cap up;
a vent contact portion extending outward from the center of the safety vent and contacting a lower surface of the cap up; and
a vent extension portion bent from the vent contact portion and extending to an upper portion of the cap up.

3. The secondary battery as claimed in claim 2, wherein the discharge passage is formed on an upper surface of the vent contact portion.

4. The secondary battery as claimed in claim 2, wherein the discharge passage is formed in a portion adjacent to the vent center portion on the vent contact portion.

5. The secondary battery as claimed in claim 2, wherein a depth of the discharge passage is 0.05 mm or less.

6. The secondary battery as claimed in claim 2, wherein the discharge passage includes:
a plurality of annular passages having concentric circles;
a plurality of straight passages connected to the plurality of annular passages and radially formed and spaced apart from each other; and
a plurality of partition walls interposed between the plurality of annular passages.

7. The secondary battery as claimed in claim 6, wherein the plurality of straight passages open portions of an interface between the vent contact portion and the vent center portion.

8. The secondary battery as claimed in claim 6, wherein the straight passages are formed to be inclined so as to increase in depth from the outside to the inside.

9. The secondary battery as claimed in claim 6, wherein the annular passages include:
a first annular passage having a first diameter; and
a second annular passage having a second diameter greater than the first diameter,
wherein a depth of the first annular passage is greater than a depth of the second annular passage.

10. The secondary battery as claimed in claim 9, wherein the partition walls include:
a first partition wall located inside the first annular passage; and
a second partition wall interposed between the first annular passage and the second annular passage,
wherein the first partition wall and the second partition wall are separated into a plurality of parts by the straight passages.

11. The secondary battery as claimed in claim 10, wherein the annular passages further include a third annular passage having a third diameter greater than the second diameter, wherein a depth of the second annular passage is greater than a depth of the third annular passage.

12. The secondary battery as claimed in claim 11, wherein the partition walls further include a third partition wall interposed between the second annular passage and the third annular passage.

13. The secondary battery as claimed in claim 1, wherein the cap up includes:
a terminal portion convexly formed upward in the center thereof; and
a coupling portion positioned on an outer periphery of the terminal portion and to which the safety vent is coupled,
wherein the discharge passage faces a lower surface of the coupling portion.
